(19) United States
(12) Patent Application Publication
(10) Pub. No.: US 2019/0294141 A1
(43) Pub. Date: Sep. 26, 2019

(54) A SYSTEM AND METHOD FOR PROVIDING A SECURE DATA MONITORING SYSTEM IMPLEMENTED WITHIN FACTORY OR PLANT

(71) Applicant: HALO DIGITAL LTD, Tel Aviv (IL)

(72) Inventors: Achiel KRAUZ, Tel Aviv (IL); Ran HAREL, Oranit (IL)

(21) Appl. No.: 16/316,406

(22) PCT Filed: Jul. 11, 2017
(86) PCT No.: PCT/IL2017/050787

§ 371 Date: Jan. 9, 2019

Related U.S. Application Data
(60) Provisional application No. 62/360,750, filed on Jul. 11, 2016.

(51) Int. Cl. G05B 19/4063; G05B 23/02; G05B 19/418; H04L 29/06; H04L 9/32; H04L 9/06

(52) U.S. Cl. CPC G05B 19/4063; G05B 23/027; G05B 19/4184; H04L 2209/38; H04L 63/123; H04L 9/3236; H04L 9/0637; G05B 19/41855

(57) ABSTRACT

A method and system for providing a secure data monitoring system within a plant, implemented by the steps of: collecting data originating from multiple data sources within the plant; encrypting said data with a one-time security key, providing read-only permissions to authorized persons and computational units; authenticating the said collected data according to a set of predefined logic rules; analyzing the collected data by employing parallel processing by multiple computers in a cluster; identifying real-world scenarios and actions that take place in the plant according to said analysis; and identifying anomalies in the operation of production machines or machine sub-units according to said analysis.

### FIELD OF THE INVENTION

The presented invention generally relates to the field of factory planning and management systems. More specifically, it relates to the securing data monitoring and accumulation from multiple sources within a factory or plant.

### DISCUSSION OF RELATED ART

The monitoring of plant operation and production data is common practice in modern management of plant production systems. The acquisition and storage of production data, as well data communications among various systems in the plant is well established and known in the art.

The current state of the art does not relate to systems and data structures that simultaneously provide:
autonomous authentication of the acquired data;
validation of data integrity; and
provide a limited platform for 3^{rd} party persons and organizations (e.g. regulatory bodies) to inspect the processes and actions that take place within the plant.

### SUMMARY OF THE INVENTION

The present invention discloses a method for providing a secure data monitoring system within a plant, said method implemented by one or more processors operatively coupled to a non-transitory computer readable storage device, on which are stored modules of instruction code that when executed cause the one or more processors to perform the steps of:
collecting data originating from multiple data sources within the plant;
encrypting said data with a one-time security key, providing read-only permissions to authorized persons and computational units;
authenticating the said collected data according to a set of predefined logic rules;
analyzing the collected data by employing parallel processing by multiple computers in a cluster;
identifying real-world scenarios and actions that take place in the plant according to said analysis; and
identifying anomalies in the operation of production machines or machine sub-units according to said analysis.

According to some embodiments, the said method further comprises the steps of:
quantifying said collected data into data blocks;
assigning a unique hash value to each data block increment; and
keeping each data block's hash value in a header, wherein said header also contains the hash value pertaining to the previous data block, thus linking the two data blocks in a block chain.

According to some embodiments, the said method further comprises the process of mutual validation among multiple computers in a cluster, said process comprising the steps of:
data block headers containing expected hash values for specific data blocks are distributed among one or more computers in said cluster, and stored separately in multiple locations;
a first computer possesses an expected hash value pertaining to a specific data block;
said first computer addresses a second computer, wherein the actual said data block is stored;
said first computer validates the existence of the said data block in the designated location on the said second computer.

According to some embodiments, the said method further comprises the step of validating the existence of both data blocks by the first computer, respective to the two hash values contained within the said header, thus validating the integrity of the data block chain.

According to some embodiments, the said method further comprises the step of emitting an alert to a front end computer upon detection of a missing data block.

According to some embodiments, the said method further comprises the steps of:
reading the content of the said data block;
applying a hashing function to the said read content, to obtain a new hash value;
comparing said new hash value to the originally possessed expected hash value; and
validating the content of the data block according to said comparison.

According to some embodiments, the said method further comprises the step of emitting an alert to a front end computer upon failure of said validation.

The present invention discloses a system for providing a secure data monitoring system within a plant, said system comprising a cluster of at least one collector computer module and a cluster of at least one inspector computer module, wherein:
each said computer module comprises one or more processors operatively coupled to a non-transitory computer readable storage device, on which are stored modules of instruction code that when executed cause the one or more processors to perform the functionality of the said computer module;
said collector computer modules collect data originating from multiple data sources within the plant;
said collector computer modules further comprise a smart card module;
said smart card encrypts the collected data with a one-time security key, providing read-only permissions to authorized persons and computational units;
said collector computer modules are configured to forward said collected data to said inspector modules;
said inspector modules are configured to authenticate said collected data according to a set of predefined logic rules;
said cluster of inspector computer modules is configured to analyze the collected data by employing parallel processing among multiple inspector computer modules in the cluster;
said inspector computer modules are configured to identifying real-world scenarios and actions that take place within the plant according to said analysis; and
said inspector computer modules are configured to identify anomalies in the operation of production machines or machine sub-units according to said analysis.

According to some embodiments, the said inspector computer modules are further configured to:
quantify said collected data into data blocks;
assign a unique hash value to each data block increment; and
keeping each data block's hash value in a header, wherein said header also contains the hash value pertaining to the previous data block, thus linking the two data blocks in a block chain.

According to some embodiments, the said system is further configured to implement a process of mutual validation among multiple computers in a cluster, wherein:
said inspector modules distributes data block headers, containing expected hash values for specific data blocks among one or more inspector modules in the inspector module cluster, to be stored separately in multiple locations;
a first inspector computer module possesses an expected hash value pertaining to a specific data block;
said first inspector computer module is configured to address a second inspector computer module, wherein the actual said data block is stored;
said first inspector computer module is configured to validate the existence of the said data block in the designated location on the said second inspector computer module.

According to some embodiments, the said first inspector computer module is configured to validate the existence of both data blocks, respective to the two hash values contained within the said header, thus validating the integrity of the data block chain.

According to some embodiments, the said first inspector computer module is configured to emit an alert to a front end computer upon detection of a missing data block.

According to some embodiments the said first inspector computer module is further configured to:
read the content of the said data block;
apply a hashing function to the said read content, to obtain a new hash value;
compare said new hash value to the originally possessed expected hash value; and
validate the content of the data block according to said comparison.

According to some embodiments the said first inspector computer module is further configured to emit an alert to a front end computer upon failure of said validation.

### BRIEF DESCRIPTION OF THE DRAWINGS

FIG. 1 presents a block diagram, elaborating the overall structure of the invented system, according to some embodiments of the present invention.

FIG. 2 presents a flow diagram describing the collection of raw data via the collectors cluster, according to some embodiments of the present invention.

FIG. 3 presents a flow diagram describing the analysis of input streams on the inspectors' cluster, according to some embodiments of the present invention.

FIG. 4 presents a flow diagram depicting the process of distributed block-chain knowledgebase construction on the inspectors' cluster, according to some embodiments of the present invention.

FIG. 5 presents a block diagram depicting the implementation of a distributed block-chain knowledgebase on the inspectors' cluster, according to some embodiments of the present invention.

FIG. 6 presents a flow diagram depicting the process of mutual validation of data blocks within the inspectors' cluster, according to some embodiments.

FIG. 7 presents a block diagram depicting the implementation of mutual validation of data blocks within the inspectors' cluster, according to some embodiments of the present invention.

FIG. 8 presents a flow diagram describing the process of addressing the inspector cluster [3100] through the front-end dedicated collector, according to some embodiments of the present invention.

FIG. 9 presents a flow diagram describing the process of addressing the inspector cluster [3100] through a smart-card host, according to some embodiments of the present invention.

### DETAILED DESCRIPTION OF SOME EMBODIMENTS OF THE INVENTION

The content of the application 62/346,681 is incorporated by reference in its entirety.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

Following is a table of definitions of the terms used throughout this application.

| Term | Definition |
|---|---|
| Smart- | The term “smart card host” is used to describe a computer |
| card | that possesses a smart-card interface or that physically |
| host | integrates a smart-card, as a mean of identification and |
| | access authorization to data within the system. |
| | Smart-card host access is facilitated either through the front |
| | end server and the dedicated front end collector, or through |
| | a dedicated inspector host on the inspectors' cluster. |
| | Smart card hosts [2400-B] are granted viewing permissions |
| | to the data communicated over the inspectors' cluster. This |
| | data may not be changed via smart card hosts. |
| | Smart-cards are distributed as a means of additional data |
| | safety, according to the discretion of authorized personnel |
| | within the plant. |
| Inspector | Inspector hosts are computers which serve as building |
| hosts | blocks of an inspector cluster. Inspector hosts comprise |
| | a non-transitory computer readable storage device and |
| | one or more processors operatively coupled to the storage |
| | device on which are stored modules of instruction code |
| | executable by the one or more processors. |
| | Execution of the said instruction code, by the said one or |
| | more processors, implements the functionality of the |
| | inspector hosts as elaborated below. |
| | The Inspectors partake in cluster computing; analyzing |
| | incoming data, storing and validating the said data, and |
| | producing alerts en-route the front end. |
| Collector | Collector hosts are computers which serve as building |
| hosts | blocks of a collectors' cluster. Collector hosts comprise a |
| | non-transitory computer readable storage device and one |
| | or more processors operatively coupled to the storage |
| | device on which are stored modules of instruction code |
| | executable by the one or more processors. |
| | Execution of the said instruction code, by the said one |
| | or more processors, implements the functionality of the |
| | collector hosts, including at least part of: |
| | collecting and buffering raw data input streams from |
| | external data sources (e.g. production machines and sensor |
| | within a plant); |
| | encrypting said data by means of a smart card; and |
| | forwarding said data to the inspector cluster. |

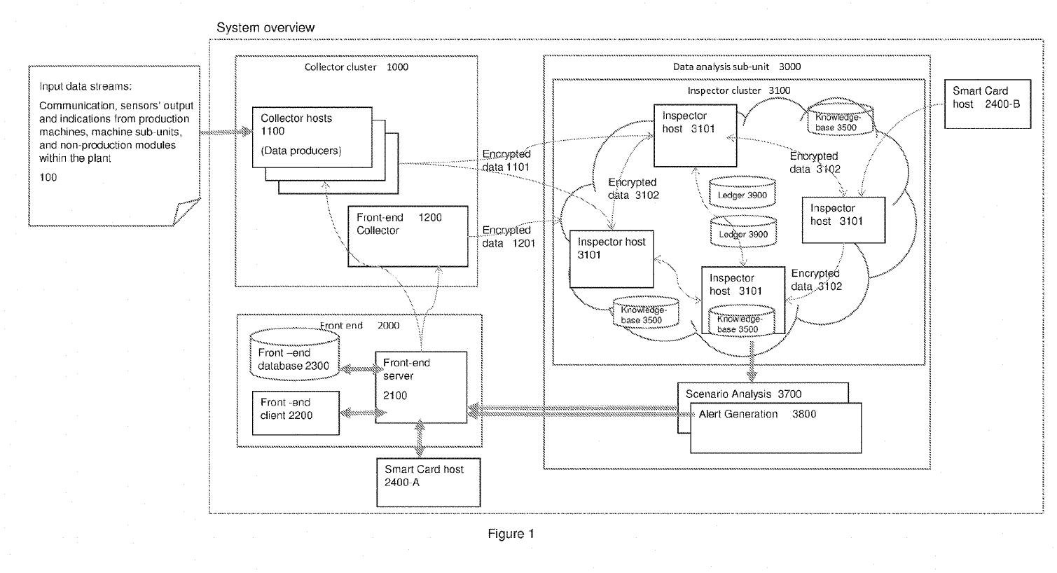

FIG. 1 presents a block diagram, elaborating the overall structure of the invented system.

As stated above, the content of the application 62/346,681 is incorporated by reference in its entirety, and will not be repeated henceforth for the purpose of brevity.

The front end environment [2000] is an encrypted environment separated from the collector cluster [1000] and data analysis subsystems. It serves as an administrative interface for configuring, monitoring and controlling the system. The front end environment is comprised of the front end server [2100], client [2200] and database [2300].

The front end server [2100] is responsible for the following administrative tasks:
Authenticating the identity of logged-in users
Facilitating an interface for acting upon alerts and notifications in real time
Managing the system configuration, appearance and function and
Managing the front end database

The front end server receives indications of events from the scenario analysis [3700] and alert generation [3800] modules. It consequently:
1. Saves the indicated events' data on the front end database
2. Notifies authorized users regarding the said indications via the front-end client [2200] or smart card host computers [2400-A].

The front end server [2100] may be accessed by authorized users either from within the front end environment, through the front-end client [2200], or from outside the front end environment, through a smart card host [2400-A]

The front-end client [2200] and smart card host [2400-A] facilitate the following capabilities:
Querying of data from the distributed knowledgebase on the inspector cluster
Customization of system appearance
Customization and configuration of the inspector cluster, by issuing requests to a dedicated configuration front end collector [1200].
Customization and configuration of the collector cluster, by issuing control messages to the collector hosts [1100]
Approval and management of system alerts.

The front end Database [2300] accumulates the following data
Indications from the Scenario analysis module [3700]
Alerts that have been received from the Alerts Generation module [3800]
Responses to queries that have addressed the distributed knowledgebase on the inspector cluster

Inspector hosts 3101 are computers which serve as building blocks of the inspectors' cluster 3100. The Inspectors partake in cluster computing, e.g.: analyzing incoming data, storing required information, and producing alerts information en-route the front end.

According to some embodiments, the inspector hosts jointly implement a distributed block chain knowledgebase 3500, providing a secure system for monitoring events that take place within the plant.

According to some embodiments, the inspector hosts further implement a distributed ledger, providing a secure system for reporting data pertaining to events that have taken place within the plant to a 3^{rd} party person or organization. The said reported data is devoid of information that is either irrelevant or unauthorized to the said 3^{rd} party person or organization.

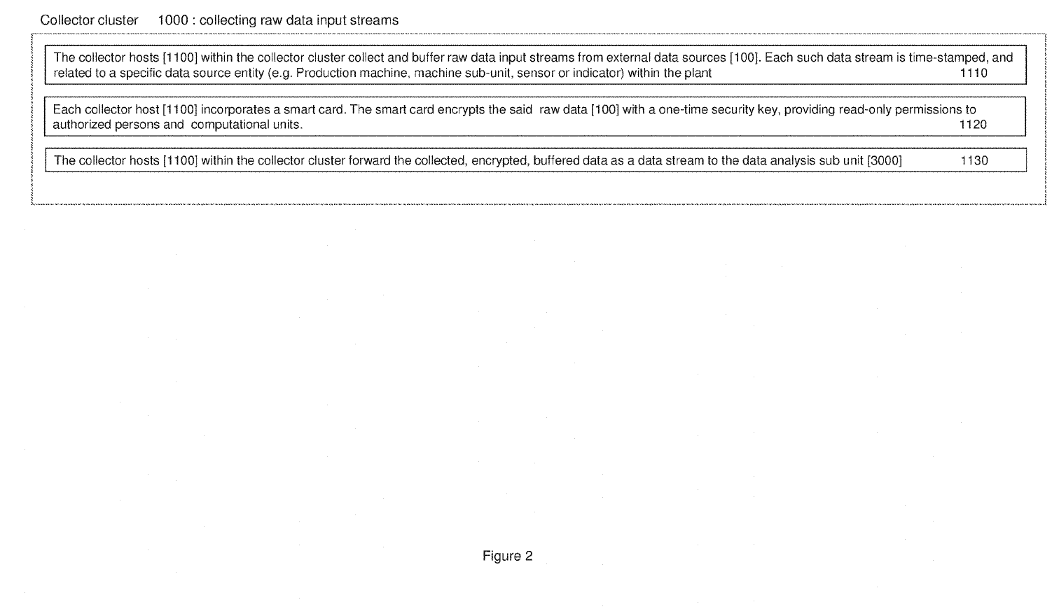

FIG. 2 presents a flow diagram describing the collection of raw data via the collectors' cluster.

The collector hosts [1100] within the collector cluster collect and buffer raw data input streams from external data sources [100]. Each such data stream is time-stamped, and related to a specific data source entity (e.g. Production machine, machine sub-unit, sensor or indicator) within the plant (step 1110).

Each collector host [1100] incorporates a smart card, which encrypts the said raw data [100] with a one-time security key, providing read-only permissions to authorized persons and computational units (step 1120).

The collector hosts [1100] within the collector cluster [1000] forward the collected, encrypted, buffered data as a data stream to the data analysis sub unit [3000].

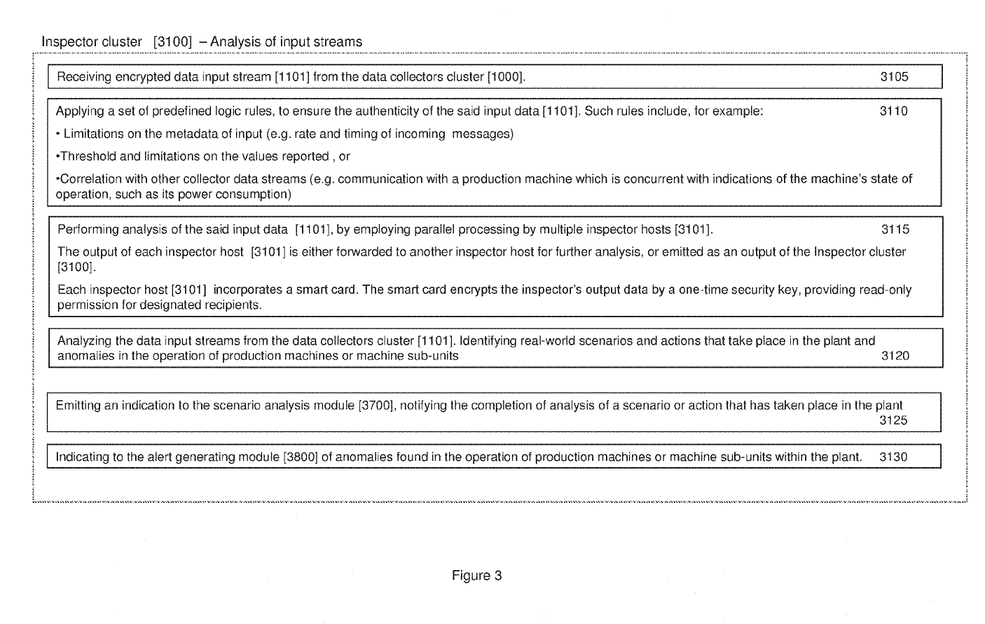

FIG. 3 presents a flow diagram describing the analysis of input streams on the inspectors' cluster, according to some embodiments of the present invention. [3100].

The inspectors' cluster [3100] receives encrypted data input streams [1101] from the data collectors' cluster [1000] (step 3105).

The inspector s' cluster [3100] applies a set of predefined logic rules, to ensure the authenticity of the said input streams [1101] (step 3110). Such rules include, for example:
Limitations on the metadata of input (e.g. rate and timing of incoming messages);
Threshold and limitations of the reported values (e.g.: measured values of specific sensors within a working range); and
Correlation with other collector data streams (e.g. data communication with a production machine which is concurrent with indications regarding the machine's actual state of operation, such as its power consumption).

The inspector cluster [3100] performs analysis of the said encrypted input data [1101], by employing parallel processing by multiple inspector hosts [3101] (step 3115). The output of each inspector host [3101] is either forwarded to another inspector host for further analysis in an encrypted form 3102, or emitted as an output of the inspector cluster [3100].

Each inspector host [3101] incorporates a smart card. The said smart card encrypts the inspector host's [3101] data output by a one-time security key, enabling only the designated recipients to read this output (step 3115).

The inspectors' cluster [3100] is configured to analyze the data input streams from the data collectors cluster [1101] (step 3120) and identify real-world scenarios and actions that take place in the plant based on the said analysis. For example, the inspectors' cluster [3100] may be configured to correlate between the input data originating from a plurality of motor decoders on a robotic arm, and identify a specific action performed by that robotic arm (e.g. assembling a vehicle module) According to some embodiments, the inspectors' cluster [3100] may be configured to correlate between different input data streams, and identify anomalies in the operation of production machines or machine sub-units. For example, the inspectors' cluster [3100] may be configured to correlate between the readings of a current meter and a motor's decoder, and detect excessive current draw of that specific motor.

The inspectors' cluster [3100] emits an indication to the scenario analysis module [3700], notifying the completion of analysis of a scenario or action that has taken place within the plant (step 3125).

The inspectors' cluster [3100] indicates to the alert generating module [3800] of anomalies found in the operation of production machines or machine sub-units within the plant (step 3130).

The inspector cluster [3100] stores elaborate data collected from collectors [1100] in a distributed, block-chain data structure, henceforth referred to as the knowledgebase [3500]. This information includes, for example:
Actions and scenarios that have taken place within the plant;
Changes made in the configuration of any part of the system (e.g. within the inspectors' cluster or the collectors' cluster);
Outcome of any read or write access made by any user (i.e. either from within the front end administrative interface or via a smart-card host) to any machine within the system (e.g. collector host or inspector host);
Parameters of correlation between independent data streams [100], portraying the mutual effect of physical entities (e.g. Production machines and machine sub-units) on each other; and
Parameters of correlation between independent data streams [100], portraying the effect of the operation of physical entities (e.g. Production machines and machine sub-units) on conditions measured by sensors and detectors within the plant.

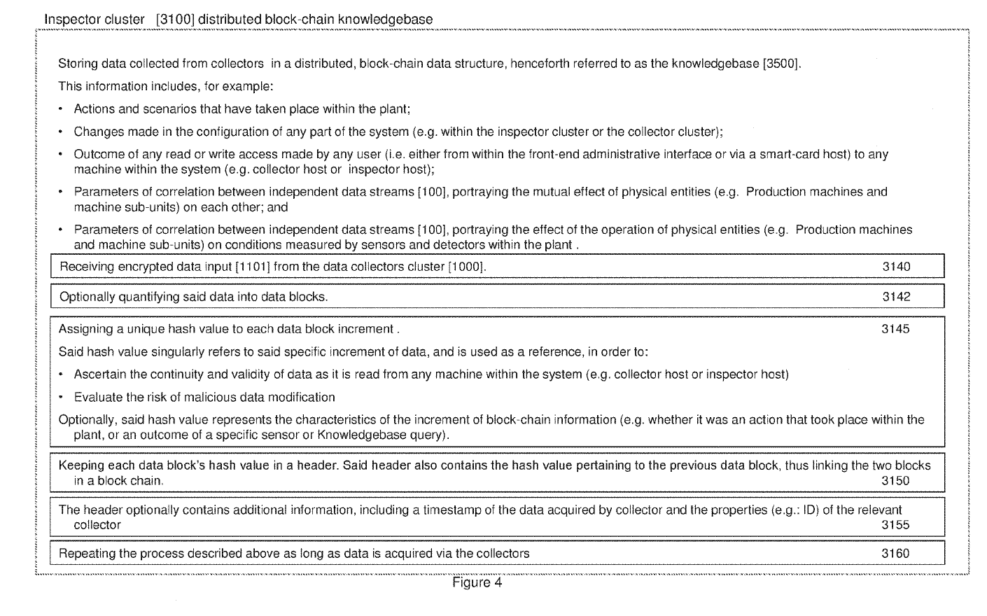

FIG. 4 presents a flow diagram depicting the process of constructing a distributed block-chain knowledgebase on the inspectors' cluster, according to some embodiments of the present invention. The inspectors' cluster [3100] stores data collected from collectors [3100] in a distributed, block-chain data structure, henceforth referred to as the knowledgebase [3500]. The information stored on the knowledgebase includes, for example:
Data regarding actions and scenarios that have taken place within the plant;
Changes that have been made in the configuration of any part of the system (e.g. within the inspector cluster or within the collector cluster);
Outcome of any read or write access made by any user (i.e. either from within the front-end administrative interface or via a smart-card host) to any machine within the system (e.g. collector host or inspector host);
Parameters of correlation between independent data streams [100], portraying the mutual effect of physical entities (e.g. Production machines and machine sub-units) on each other; and
Parameters of correlation between independent data streams [100], portraying the effect of the operation of physical entities (e.g. Production machines and machine sub-units) on conditions measured by sensors and detectors within the plant.

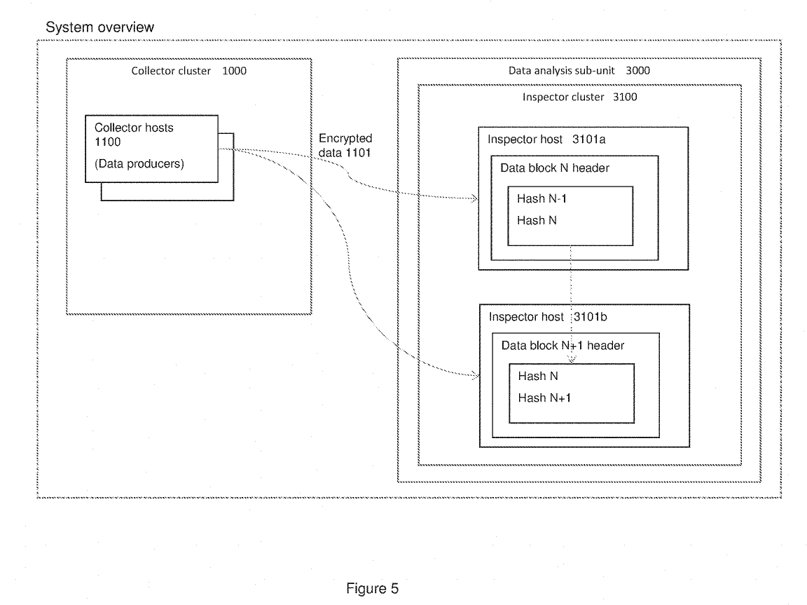

Reference is now made to FIG. 5, presenting a block diagram which graphically depicts and clarifies the implementation of a distributed block-chain knowledgebase on the inspectors' cluster [3100] as described in FIG. 4.

The inspectors' cluster [3100] receives encrypted data as a data input stream [1101] from the data collectors cluster [1000] (step 3140). According to some embodiments, the said input data is quantified into data blocks (step 3142).

According to some embodiments, each collector host [1100] within the collector cluster [1000] is configured to propagate the said data input stream [1101] to a specific inspector host [3101, 3101b], according to a predefined set of rules. For example, the collector host [1100] may be configured to propagate the data input stream [1101] to a specific inspector host [3101, 3101b], according to:
predefined lists of prioritized inspector hosts;
specific scenarios and actions that take place in the plant, and are related to the machines that have produced the said data input stream [1101];
load balancing considerations among inspector hosts, etc.

The inspectors' cluster [3100] assigns each data block increment a unique hash value, which singularly refers to that specific increment of data (step 3145).

According to one embodiment, the said hash value represents the characteristics of the increment data block. For example, the hash value may indicate whether the data block originates from an action that has taken place within the plant, an outcome of a specific sensor within the plant or a response to a knowledgebase query performed by a user.

The hash value is used as a reference, in order to:
Ascertain the continuity and validity of data as it is read from any machine within the system (e.g. collector host or inspector host); and
Evaluate the risk of malicious data modification.

The said Block-chain information hash values may be exported and viewed by authorized 3^{rd} party persons and organizations as a reference to the actions and scenarios that they represent. This capability may, for example, facilitate the inspection of process quality and safety by external regulatory bodies.

The inspectors' cluster [3100] keeps each data block's hash value in a header. The said header also contains the hash value pertaining to the previous data block, thus linking the two blocks in a chain (step 3150), henceforth referred to as the knowledgebase block chain. In the example provided in FIG. 5, this link is evident through the inclusion of the hash value for data block N on both the header of data block N and header of data block N+1.

The said headers (of data blocks N and N+1) may be stored on the same inspector host, or distributed on separate inspector hosts (e.g.: 3101a, 3101b) within the inspectors' cluster.

According to some embodiments, the header contains additional information, including a timestamp of the data acquired by collector and the properties of the relevant collector (e.g.: the collector's ID) (step 3155).

The inspectors' cluster [3100] repeats the process described above, and elongates the knowledgebase block chain as long as data is acquired via the collectors (step 3160).

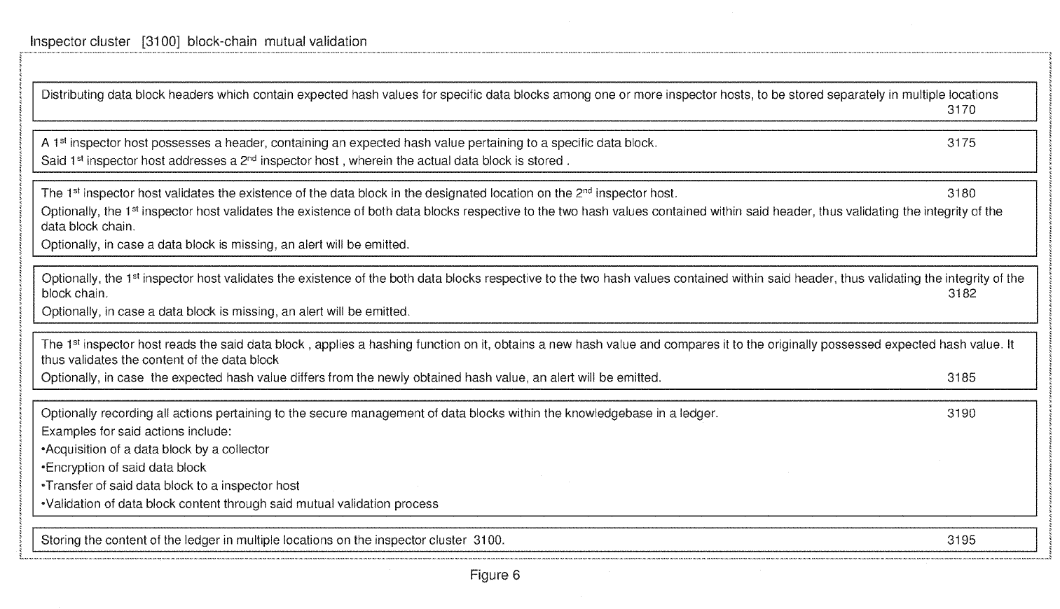

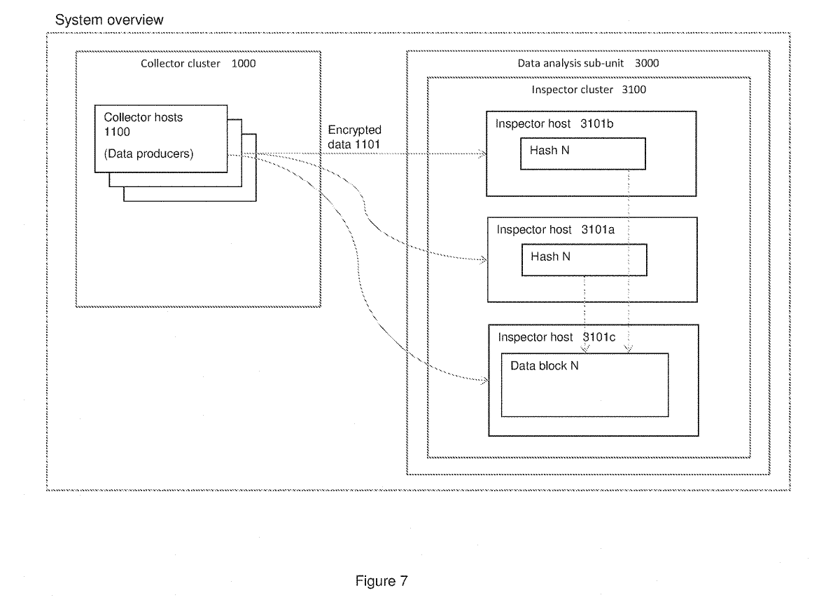

FIG. 6 presents a flow diagram depicting the process of mutual validation of data blocks within the inspectors' cluster, according to some embodiments of the present invention. Reference is also made to FIG. 7, presenting a block diagram which graphically depicts and clarifies the implementation of a mutual validation as described in FIG. 6 according to some embodiments of the present invention.

The data block headers containing expected hash values for specific data blocks are distributed by the inspector hosts among one or more inspector hosts [3101a, 3101b, 3101c], and stored separately in multiple locations (step 3170).

According to some embodiments, the inspector hosts perform the distribution of data block headers among themselves, according to a predefined configuration. The said configuration takes into account considerations such as:
physical location;
load balancing;
relevance of specific data blocks to specific actions and scenarios that take place within the plant, etc.

A first inspector host [3101a or 3101b] possesses a header containing an expected hash value, pertaining to a specific data block N. The said first inspector host addresses a second inspector host [3101c], wherein the actual data block N is stored (step 3175).

According to some embodiments, the said first inspector host may addresses the second inspector host upon a predefined trigger event, for example:
a communication of specific data over communication lines between sensors and collector hosts, or between collector hosts and inspector hosts;
a periodic time trigger; or
a query made by an administrator.

The first inspector host [3101a or 3101b] validates the existence of the data block in the designated location on the second inspector host [3101c] (step 3180).

According to some embodiments, the first inspector host [3101a or 3101b] is configured to validate the existence of the both data blocks, respective to the two hash values contained within said header. It thus validates the integrity of the data block chain.

According to some embodiments, in the event that a data block has been found missing, the first inspector host will emit an indication to the alert generation module [3800], which in turn may alert administrators via the front end server [2100].

The first inspector host [3101a or 3101b] reads the said data block, and applies an appropriate hash function on it, to obtain a new hash value. The first inspector host compares the said newly obtained hash value with the expected hash value in its possession, to validate the content of the data block (step 3185).

According to some embodiments, in the event that a the expected hash value is substantially different than the newly obtained hash value, the first inspector host will emit an indication to the alert generation module [3800], which in turn may alert administrators via the front end server [2100].

According to some embodiments of the present invention, the inspector host cluster further implements a ledger [3900], distributed among one or more inspector hosts. The said ledger provides a secure system for reporting data pertaining to events that have taken place within the plant to a 3^{rd} party person or organization.

The ledger records events pertaining to the secure management of data blocks within the knowledgebase (step 3190), including for Example:
Obtaining a data block by a collector;
Encryption of a data block by a collector;
Transfer of said data block to an inspector host; and
Validation of data block content through the mutual validation process described above.

According to some embodiments, the data is recorded in the ledger is devoid of information that is either irrelevant or unauthorized for viewing by said 3^{rd} party persons or organizations.

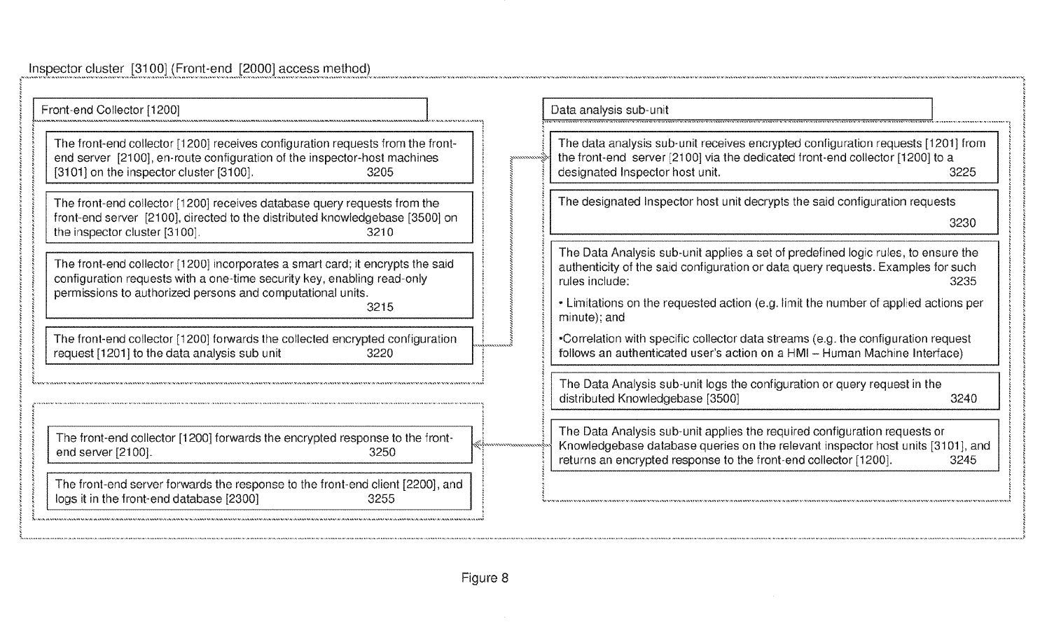

FIG. 8 presents a flow diagram describing the process of addressing the inspector cluster [3100] through the front end dedicated collector [1200] in order to perform inspector cluster [3100] configuration, inspector host configuration [3101] and knowledgebase [3500] queries according to some embodiments of the present invention.

The front end collector [1200] receives configuration requests from the front end server [2100], en-route configuration of the inspector-host machines [3101] on the inspector cluster [3100] (step 3205).

The front end collector [1200] receives database query requests from the front end server [2100], directed to the distributed knowledgebase [3500] on the inspector cluster [3100]. These knowledgebase queries are limited to a predefined subset of possible queries, according to predefined permissions assigned to front end users (step 3210).

The front end collector [1200] incorporates a smart card; it encrypts the said configuration requests with a one-time security key, enabling read-only permissions to authorized persons and computational units (step 3215).

The front end collector [1200] forwards the collected encrypted configuration request [1201] to the data analysis sub unit (step 3220).

The data analysis sub-unit receives encrypted configuration requests [1201] from the front end server [2100] via the dedicated front end collector [1200] to a designated inspector host unit (step 3225). The designated inspector host unit decrypts the said configuration requests (step 3230).

The data analysis sub-unit applies a set of predefined logic rules, to ensure the authenticity of the said configuration or data query requests (step 3235). Examples for such rules include:
Limitations on the requested action (e.g. limit the number of applied actions per minute); and
Correlation with specific collector data streams (e.g. the configuration request follows an authenticated user's action on a HMI—Human Machine Interface).

The data analysis sub-unit logs the configuration or query request in the distributed knowledgebase [3500] (step 3240).

The data analysis sub-unit applies the required configuration requests or knowledgebase database queries on the relevant inspector host units [3101], and returns an encrypted response to the front end collector [1200] (step 3245).

The front end collector [1200] forwards the encrypted response to the front end server [2100] (step 3250). The front end server forwards the response to the front-end client [2200], and logs it in the front end database [2300] (step 3255).

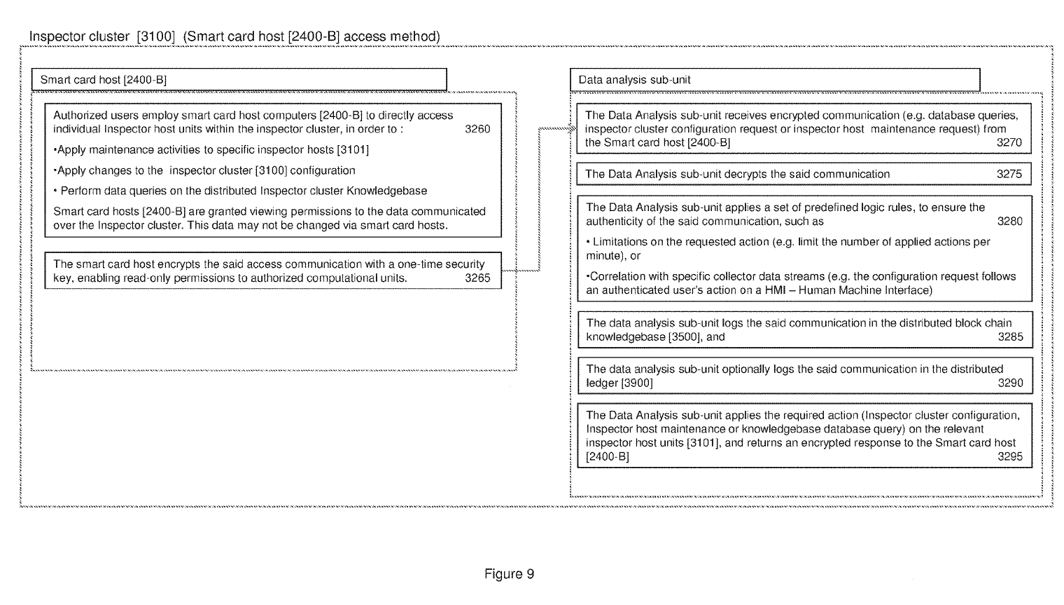

FIG. 9 presents a flow diagram describing the process of addressing the inspector cluster [3100] through a smart-card host, in order to perform inspector cluster [3100] configuration, inspector host maintenance [3101] and knowledgebase [3500] queries.

Authorized users employ smart card host computers [2400-B] to directly access individual inspector host [3101] within the inspector cluster, and perform at least part of the following (step 3260):
Apply maintenance activities to specific inspector hosts [3101];
Apply changes to the inspector cluster [3100] configuration; and
Perform data queries on the distributed inspector cluster knowledgebase.
   Smart card hosts [2400-B] are granted viewing permissions to the data communicated over the inspector cluster.

According to some embodiments, the data communicated over the inspector cluster may not be changed via smart card hosts.

The smart card host encrypts the said access communication with a one-time security key, enabling read-only permissions to authorized computational units (step 3265).

The data analysis sub-unit receives encrypted communication (e.g. database queries, inspector cluster configuration request or inspector host maintenance request) from the smart card host [2400-B] (step 3270)
The data analysis sub-unit decrypts the said communication (step 3275) and applies a set of predefined logic rules, to ensure the authenticity of the said communication (step 3280). The said predefined logic rules may include, for example: Applying limitations on the action requested by the smart card host [2400-B] (e.g. limit the number of applied actions per minute); and
Ensuring existence of a correlation among specific collector data streams (e.g. the require that a configuration request would follow an authenticated user's action on a HMI—Human Machine Interface).

The data analysis sub-unit logs the said communication in the distributed knowledgebase [3500] (step 3285).

According to some embodiments, the data analysis sub-unit logs the said communication in the distributed ledger [3900] (step 3290).

The data analysis sub-unit applies the required action (inspector cluster configuration, inspector host maintenance or knowledgebase database query) on the relevant inspector host units [3101], and returns an encrypted response to the smart card host [2400-B] (step 3295).

1. A method for providing a secure data monitoring system within a plant, said method implemented by one or more processors operatively coupled to a non-transitory computer readable storage device, on which are stored modules of instruction code that when executed cause the one or more processors to perform the steps of:
collecting data originating from multiple data sources within the plant;
encrypting said data with a one-time security key, providing read-only permissions to authorized persons and computational units;
authenticating the said collected data according to a set of predefined logic rules;
analyzing the collected data by employing parallel processing by multiple computers in a cluster;
identifying real-world scenarios and actions that take place in the plant according to said analysis; and
identifying anomalies in the operation of production machines or machine sub-units according to said analysis.

2. The method of claim 1, further comprising the steps of:
quantifying said collected data into data blocks;
assigning a unique hash value to each data block increment; and
keeping each data block's hash value in a header, wherein said header also contains the hash value pertaining to the previous data block, thus linking the two data blocks in a block chain.

3. The method of claim 2, further comprising a process of mutual validation among multiple computers in a cluster, said process comprising the steps of:
data block headers containing expected hash values for specific data blocks are distributed among one or more computers in said cluster, and stored separately in multiple locations;
a first computer possesses an expected hash value pertaining to a specific data block;
said first computer addresses a second computer, wherein the actual said data block is stored;
said first computer validates the existence of the said data block in the designated location on the said second computer.

4. The method of claim 3, wherein the first computer is configured to validate the existence of both data blocks, respective to the two hash values contained within the said header, thus validating the integrity of the data block chain.

5. The method of claim 3, whereupon detection of a missing data block, an alert is emitted to a front end computer.

6. The method of claim 3, wherein the said the first computer is further configured to:
read the content of the said data block;
apply a hashing function to the said read content, to obtain a new hash value;
compare said new hash value to the originally possessed expected hash value; and
validate the content of the data block according to said comparison.

7. The method of claim 6, wherein an alert is emitted to a front end computer upon failure of said validation.

8. A system for providing a secure data monitoring system within a plant, said system comprising a cluster of at least one collector computer module and a cluster of at least one inspector computer module, wherein:
each said computer module comprises one or more processors operatively coupled to a non-transitory computer readable storage device, on which are stored modules of instruction code that when executed cause the one or more processors to perform the functionality of the said computer module;
said collector computer modules collect data originating from multiple data sources within the plant;
said collector computer modules further comprise a smart card module;
said smart card encrypts the collected data with a one-time security key, providing read-only permissions to authorized persons and computational units;
said collector computer modules are configured to forward said collected data to said inspector modules;
said inspector modules are configured to authenticate said collected data according to a set of predefined logic rules;
said cluster of inspector computer modules is configured to analyze the collected data by employing parallel processing among multiple inspector computer modules in the cluster;
said inspector computer modules are configured to identifying real-world scenarios and actions that take place within the plant according to said analysis; and
said inspector computer modules are configured to identify anomalies in the operation of production machines or machine sub-units according to said analysis.

9. The system of claim 8, wherein said inspector computer modules are configured to:
quantify said collected data into data blocks;
assign a unique hash value to each data block increment; and
keeping each data block's hash value in a header, wherein said header also contains the hash value pertaining to the previous data block, thus linking the two data blocks in a block chain.

10. The system of claim 9, further implementing a process of mutual validation among multiple computers in a cluster, wherein:
said inspector modules distributes data block headers, containing expected hash values for specific data blocks among one or more inspector modules in the inspector module cluster, to be stored separately in multiple locations;
a first inspector computer module possesses an expected hash value pertaining to a specific data block;
said first inspector computer module is configured to address a second inspector computer module, wherein the actual said data block is stored;
said first inspector computer module is configured to validate the existence of the said data block in the designated location on the said second inspector computer module.

11. The system of claim 10, wherein the said first inspector computer module is configured to validate the existence of both data blocks, respective to the two hash values contained within the said header, thus validating the integrity of the data block chain.

12. The system of claim 10, wherein the said first inspector computer module is configured to emit an alert to a front end computer upon detection of a missing data block.

13. The system of claim 10, wherein the said the first inspector computer module is further configured to:
read the content of the said data block;
apply a hashing function to the said read content, to obtain a new hash value;
compare said new hash value to the originally possessed expected hash value; and
validate the content of the data block according to said comparison.

14. The system of claim 13, wherein the said first inspector computer module is further configured to emit an alert to a front end computer upon failure of said validation.
